(19) United States
(12) Patent Application Publication
(10) Pub. No.: US 2005/0064069 A1
(43) Pub. Date: Mar. 24, 2005

(54) Small girthed ice articles and trays for making same

(76) Inventor: Thomas F. Adams, Ft. Myers, FL (US)

Correspondence Address: Werner H. Schroeder, 5550 Heron Point Dr. # 1105, Naples, FL, 34108, US

(21) Appl. No.: 10/667,809

(22) Filed: Sep. 22, 2003

(51) Int. Cl. A23L 2/00

(52) U.S. Cl. 426/66

(57) ABSTRACT

Small girthed ice articles referred to as “ice sticks” having a girth allowing them to be easily placed through narrow openings and passages, and trays for the making of the same. A first form of the ice stick has a rectangular shape, a flat upper surface and tub-shaped sidewall, and having rounded corners. Preferred dimensions are on the order of: four inches long, about three-quarters of an inch wide, and about one half of an inch deep. A second form of an ice stick has a generally elliptical cross-section sidewall which gently tapers from an upper face toward an opposite bottom face. Preferred dimensions thereof are on the order of: about three inches long, wherein at the upper face the ellipse has a major axis of about three-quarters of an inch and a minor axis of about one-half of an inch, and wherein at the lower face the ellipse has a major axis of about three-eights of an inch to about seven-sixteenth of an inch, however theses dimensions may be varied from these. To provide the first form of sticks sticks, a multi-compartmented lateral tray is provided, preferably formed of plastic. Each compartment is shaped complimentary to the aforementioned shape of the sidewall of the first form of ice stick. To provide the second form of ice stick, a vertical tray is provided, preferably formed of plastic, having a plurality of vertical compartments which are closed at the bottom, and each having the cross-sectional shape of the sidewall of the second form of ice stick.

### CROSS REFERENCE TO RELATED APPLICATIONS

This application is a Subtitute for application Ser. No. 09/493,650 having a filing date of Jan. 29, 2000 presently abandoned.

### STATEMENT REGARDING FED SPONSORED R & D

(none)

### BACKGROUND OF THE INVENTION

Field of the Invention

The present invention relates to ice cubes and more particularly to small girthed ice articles, hereinafter referred to as “ice sticks”, wherein the ice sticks are placeable through narrow necks and openings of containers such as beer or soda cans. Still more particularly, the present invention is related to trays configured for making the ice sticks

2. Description of the Related Art

Ice cubes are commonly provided and used by pouring potable water into a compartmentalized ice cube tray, placing the tray into a freezer to freeze the water into ice cubes, removing the ice cubes from the tray, and , finally placing the ice cubes into a drink filled container as for example a glass or a cup. Ice cubes for the last six decades have been basically the same shape and size, for example, about one inch wide, and about one and a half to two inches long.

Just prior to WWII, home refrigerators included a small freezer compartment and two aluminum ice cube trays which usually included a “pry bar” to free the frozen ice cubes from the metal dividers and tray. Although some plastic trays came to market in the seventies, metal trays and dividers with “built-in” injector handles/levers were still popular through the seventies and eighties. Plastic trays of high density polyethylene with individual (molded in) cube cavities came into increasing favor to produce ice cubes, which were generally of the same basic size and shape. Multi-cavity ice cube trays of injection molded high density polyethylene use dies (i.e. molds) with highly polished (even chrome plated) cavity surfaces in order to mirror-finish ice cubes (with rounded bottom edges) which can easily be released by simply twisting the tray from end to end.

Commercial ice cube making machines came into use in the sixties and later cube makers were offered as an option in home refrigerators starting in the seventies, some with dispenser features which allowed for selection between cubed or crushed ice. The cube shapes were basically conventional often with rounded bottoms, but some, particularly those that were made automatically in home refrigerators, had semi-circular shapes (i.e. “half-moon” shapes).

The regular use of conventional ice cubes through the eighties and early nineties was to put ice cubes in wide-mouth glasses for cooling soft drinks, cocktails, iced water etc. Also popular were ice cubes used in (wide-mouthed) picnic jugs for Kool Aid, lemonade, ice tea etc. Ice cubes also were used to fill ice chests for cooling of cans and bottles of one's favorite liquid refreshment.

There was a slight underlying need for an ice cube shape that would fit into regular narrow-mouthed vacuum bottles. But, to accomplish this feat, a user would need to reshape a conventional ice cube by melting it under running water sufficient to reduce its size so that it would fit into the vacuum bottle mouth. Many such fragile glasses and vacuum bottles were broken by the “impatient” user trying to “pound-in” square cornered cubes into the narrow opening. The only other alternative, using crushed ice, is not a viable option. This is because as the small sized pieces quickly melt, the liquid becomes diluted and the liquid is cooled only momentarily while the pieces quickly melt.

The stay-on tab beverage can, known in the seventies as a pop-top or pull-tab beverage can, is now ubiquitous, as is the screw-cap plastic beverage bottle. Indeed, the screw-cap plastic beverage bottle has the advantage of being refillable, and has become a favorite of those ( as for example, runners or bikers) wishing to carry a supply of drinking water with them.

Conventional ice cubes are typically configured of a rather cubic shape which is impossible to place into the neck of a soda bottle, the opening of a vacuum bottle or the tab opening of a stay-on tab beverage can. Accordingly persons wishing to cool liquids of these containers must typically first pour the liquid into a wide mouthed container, such as a glass or a cup, and then add ice cubes to it. This detracts from the simplicity of drinking an ice cooled liquid from a soda bottle or an opened can.

A product currently on the market attempts to produce ice sticks for use with small necked and small opening containers (i.e. soda bottles and stay-on tab cans. This product if ice Tubes, Inc., Tallmadge, Ohio 44278, is a tray having a plurality of elongated hollow cylinders which are selectively closed at one end by a removable bottom base for the making of a plurality of cylindrical ice articles, herein referred to as “ice tubes”. At first glance the ice tube product seems to address the need addressed by ice sticks in that the ice tubes are of an elongated cylindrical shape However, the two piece tray used to make ice tubes requires complex (time consuming) installation and removal procedure for the bottom base. Further, the constant diameter of the hollow cylinders of the tray make extraction of the ice cubes formed therein difficult. As a matter so difficult that they must be partially melted, such a by running hot water onto the tray in order in order for the cylindrical tubes to be extracted. The wet ice tubes then may be subject to cross freeze (that is, freeze together) if they are grouped together in a container and then placed back into a freezer. Also the diameter of the ice tube is too large to allow it to pass through the tab opening of a stay-on tab beverage can.

Accordingly, what remains needed in the art is an ice stick which fits easily into the narrow neck of a soda bottle, the small opening of a stay-on tab can or other small mouthed container (such as, for example, vacuum bottles or baby bottles), wherein the tray for its making is easy to use and provides for easy extraction of the ice sticks formed therein.

### SUMMARY OF THE INVENTION

The present invention includes small girthed ice articles, herein referred to as “ice sticks” wherein in the small girth allows them to be easily placed through small openings and narrow passages of containers. The present invention further includes trays for the making of the ice sticks according to the present invention.

A first form of the ice sticks is provided having a small girthed body, characterized by a generally rectangular shape, having a generally flat upper face and a generally tub faced sidewall having rounded corners everywhere accept where the sidewall meets the upper face. Preferred dimensions of the first form of ice sticks are in the order of about four inches long, about three quarters of an inch wide and about one half of an inch deep; the dimensions may be varied from these.

A second form of ice sticks is provided having a small a small girthed body, characterized by a generally elliptical cross-section (that is, an oval cross-section) side wall which is gently tapered from a generally flat upper surface toward an opposite bottom face. The bottom face is preferred to be gently rounded where it meets the sidewall. Preferred dimensions of the second form of the ice stick are in the order of: about three inches long, wherein at the upper face has a major axis of about three quarters of an inch and a minor axis of about one half of an inch, and wherein at the lower face of the ellipse has a major of about five-eight of an inch and a minor axis of just under one half of an inch, preferably between three eights of an inch and seven sixteenths of an inch; however, the dimensions may be varied from these.

In operation of the ice sticks according to the invention (either of the first or the second form thereof), an ice stick is grasped, oriented so that the small girth is oriented parallel with the opening cross section of the container, and then placed into the container, which may or may not be already filled with a liquid. For example, The container may be a narrow neck bottle of the type used to store soda or bottled water, wherein the small girth dimension of the ice stick admits its passage through the narrow neck. Further for example, may be a stay-on tab can, wherein the ice stick is placed through the tab opening formed by a user pulling up on the stay-on tab. Again, the small girth dimensions of the ice stick admit its easy passage through the tab opening of the can.

To provide the first form of the ice stick, a multi-compartmented lateral tray is provided, preferably formed of plastic. Each lateral compartment has a tub shaped wall complimentarily shaped to the aforementioned tub shape of the sidewall of the first form of ice stick. Preferably, the lateral tray features water overflow channels for self-leveling of the water between lateral compartments and a raised perimeter rim for preventing accidental spillage as a water-filled lateral tray is transported from a sink to a freezer. The orientation of the lateral compartments are mutually parallel, and may be longitudinal and transverse in relation to the lateral tray outside dimensions.

In one preferred aspect of the lateral tray, an ice stick chute is incorporated for directing ejected ice sticks along the chute path and out a portal (and thereupon into container). In a second preferred aspect of the lateral tray, several lateral trays may be nestably stacked and slightly tilted, whereupon a water stream (from a faucet) glancingly hitting all the trays causes all the trays to be filled simultaneously.

To provide the second form of ice sticks, a vertical tray is provided, preferably formed of plastic, having a plurality of vertical compartments which are closed at the bottom, and each having a tapering, ellipticallly cross-sectioned shape wall that is complimentary to the shape of the sidewall of the second form of ice stick. Preferably, the vertical tray features water overflow channels between lateral compartments and a raised perimeter rim for preventing accidental spillage as a water-filled lateral tray is transported between a sink and a freezer.

Accordingly it is an object of the present invention to provide an ice stick having a small girth which allows it to pass through small openings narrow necks, small mouths etc.

It is an additional object of the present invention to provide an ice stick having a small girth and an elongated shape featuring a generally flat top face abutting a generally tub shaped, rounded sidewall.

It is a further object of the present invention to provide an ice stick having a small girth an elliptical cross-section which gently tapers.

It is yet another object of the present invention to provide trays suitable for the making of ice sticks having a small girthed elongated shape featuring a generally flat top face abutting a generally tub-shaped rounded sidewall so that the ice sticks easily release from the ice stick forming compartments thereof simply by twisting the tray, whereby any wetting and/or melting of the ice sticks is obviated for release from the tray.

It is yet a further object of the present invention to provide trays suitable for making ice sticks having a small girthed and elliptical cross-section that gently tapers.

It is still another object of the present invention to provide trays for the making of ice sticks, wherein the trays are nestable together such that the trays my be filled simultaneously from a stream of water.

These and additional objects, advantages, features and benefits of the present invention will become apparent from the following specification.

### BRIEF DESCRIPTION OF THE DRAWINGS

FIG. 1 is a perspective view of a first form of the invention, shown being placed into a vacuum bottle;

FIG. 2 is a perspective view of a first form of the invention, shown being placed into an opening of a stay-on tab can;

FIG. 3 is a perspective view of a first form of the invention, shown being placed into a threaded cap plastic beverage bottle;

FIG. 4 is a perspective view of an ice stick according to a first form of the present invention;

FIG. 5 is a side view of the first form of an ice stick according to the present invention

FIG. 6 is a top view of the first form of the ice stick seen along the arrow 6 of FIG. 5;

FIG. 7 is an end view of the first form of the ice stick as seen along line 8-8 of FIG. 5;

FIG. 8 is a sectional view of the first form of the ice stick as seen along the line 8-8 of FIG. 6;

FIG. 8A is a sectional view as seen in FIG. 8, wherein the sidewall of the first form of the ice stick has a semi-circular tub shape;

FIG. 9 is a perspective view of a lateral tray according to the invention for making the first form of the ice stick according to the present invention, wherein the lateral compartments are longitudinal oriented;

FIG. 10 is a sectional view of the lateral tray, taken along 10-10 of FIG. 9;

FIG. 11 is a sectional view of the lateral tray, taken along 11-11 of FIG. 9;

FIG. 11A is a sectional view as in FIG. 11, wherein the wall thereof has a semi-circular tub shape for making the ice stick of FIG. 8A;

FIG. 12 is a perspective view of a first alternative form of the lateral tray according to the present invention;

FIG. 13 is a sectional view of the first alternative form of the lateral tray, seen along the line 13-13 of FIG. 12;

FIG. 14 is another view of the lateral tray according to the present invention, wherein the lateral compartments are transversely oriented;

FIG. 15 is a broken away sectional view of the lateral tray taken along line 15-15 of FIG. 14;

FIG. 16 is a perspective view of a second alternative form of the lateral tray, wherein four lateral trays are shown vertically stacked (nested);

FIG. 17 is a perspective view of the second alternative form of the lateral tray, wherein the four lateral trays are vertically stacked (nested) and held tilted back while each is being filled simultaneously with water;

FIG. 18 is a perspective view of a second form of the ice stick according to the present invention;

FIG. 19 is a side view of the second form of the ice stick according to the present invention;

FIG. 20 is a top plan view of the second form of the ice stick, seen along line 20 of FIG. 19;

FIG. 21 is a bottom plan view of the second form of the ice stick, seen along line 21 of FIG. 10;

FIG. 22 is an edge view of the second form of the ice stick according to the present invention;

FIG. 23 is a perspective view of a vertical tray according to the present invention for making the second form of the ice stick of the present invention;

FIG. 24 is a broken-away sectional view of the vertical tray, seen along line 24-24 of FIG. 23;

FIG. 25 is a broken-away sectional view of the vertical tray, seen along line 25-25 of FIG. 23.

### DETAILED DESCRIPTION OF THE PREFERRED EMBODIMENT

Referring now to the drawings, FIGS. 1 through 3 depict a first form of the ice stick 100 according to the present invention shown in operation with several small opening containers. It will be seen that the small girth G (see FIG. 7) of the body of the ice stick 100 allows for its easy passage through the small of a vacuum bottle 104, the tab opening 106 of a stay-on tab beverage can 10, and the small mouthed neck and opening 110 of a threaded cap plastic beverage bottle 112. By placing one or more ice sticks 100 into any of these containers, the liquid container therein will be pleasingly cooled by the one or more ice sticks while the liquid yet remains in the container. The dimensions of the ice stick provide a large surface area for excellent heat exchange with the liquid to be cooled, and the relatively large bulk size (as opposed to crushed ice pieces) allows for slow melting and for the considerable heat capacity (latent heat) of the ice stick to absorb heat of the liquid as it changes phase. Further, the shape of the ice stick is selected to not only provided large bulk and provide passage through narrow openings, but to provide sidewall shapes that allow for easy removal from compartments of trays that were used for their making.

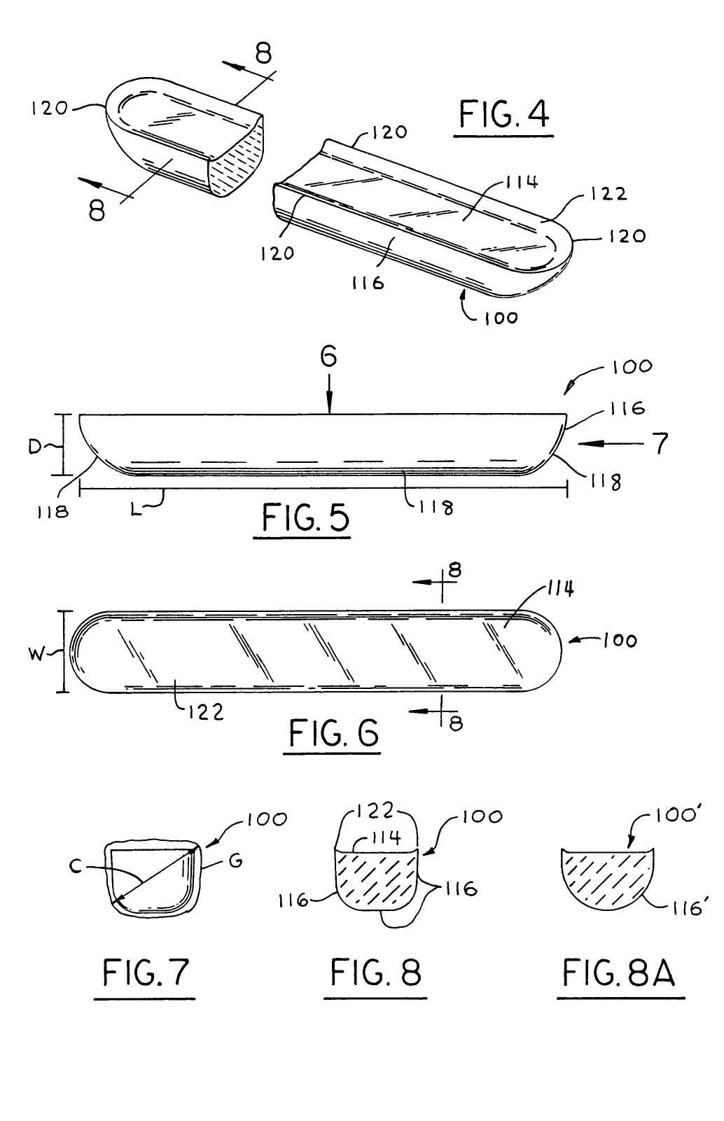

Turning now to FIGS. 4 through 8, the first form of ice stick 100 is depicted. As mentioned, the girth G of the body (that is the circumferential size thereof) is small enough to allow it to pass through small sized openings of containers, wherein the girth has a widest cross-sectional diameter C on the order of less than about one inch, preferably at or less than three-quarters of an inch, wherein seven-eighths of an inch is, approximately, the inside diameter of opening 110 of a standard screw cap plastic beverage container 112. The length may be any convenient length, as for example, between about one and five inches.

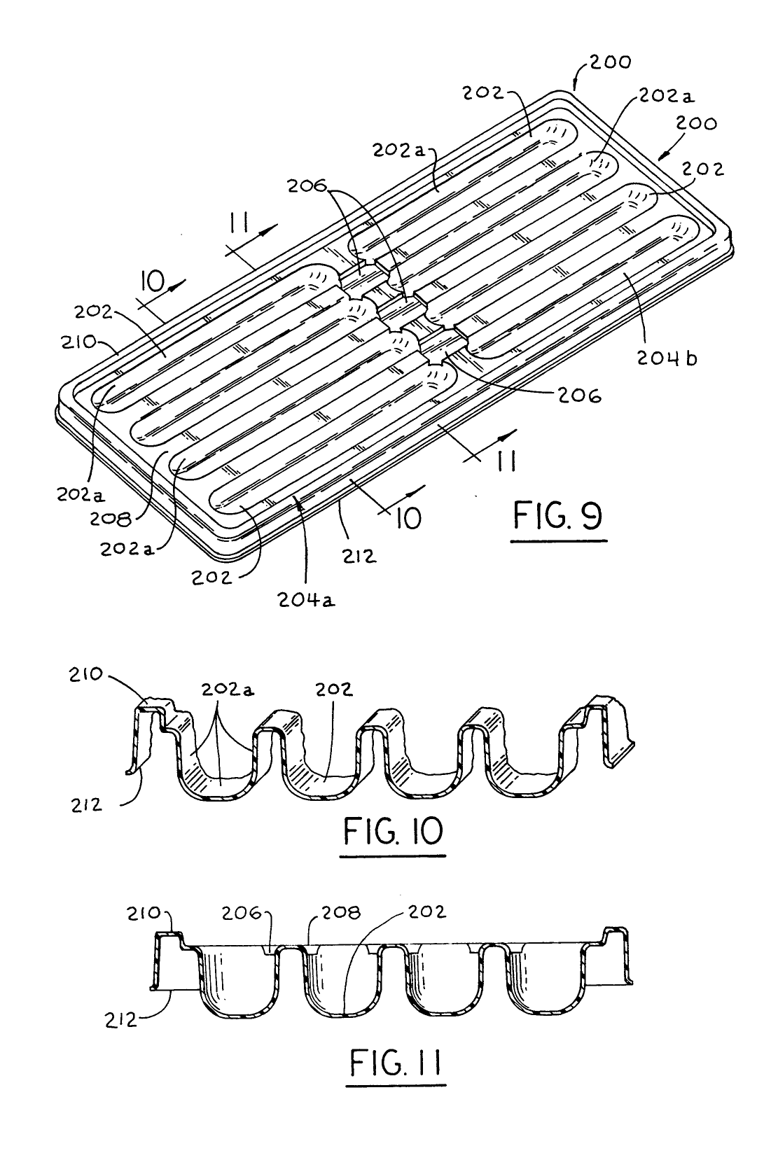

FIG. 8A depicts that the tub shape of the sidewall 116′ of the ice stick 100″ may be any rounded shape, including a semi-circular shape, as shown.

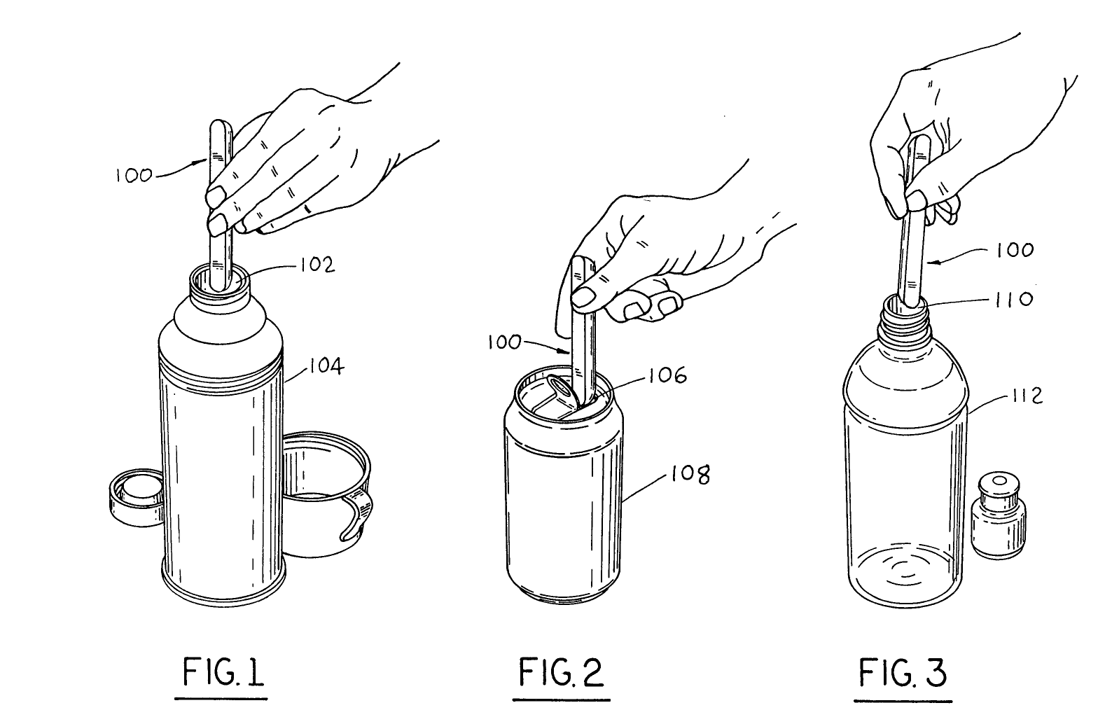

The first form of ice stick 100 is a generally rectangularly shaped body having an upper face 114 and a generally tub-shaped sidewall 116 having rounded corners 118. At the interface 120 where the sidewall 110 meets the upper face 114 a right angle corner is formed. The upper face is flat, being the result of the water level in a lateral compartment (discussed herein below) at the time of freezing. A peripheral ridge 122 will generally form at the sidewall to upper face interface 120 because of surface wetting of the water with respect to the wall (for example, see 202a of FIG. 9) of the lateral compartment of a tray used for forming the ice stick 100, and when formed is included in the cross-sectional diameter C. The length may be any convenient length, as for example, between about one to about four inches. Referring again to FIG. 2, it will be noted the rounded corners 118 of the sidewall of the sidewall 116 and the flatness of the upper face 114 complement the general configuration of the tab opening 106 of the stay-on tab can 108 (where the tab is oriented perpendicularly upward).

Preferred dimensions of the first form of the ice stick 100 are in the order of: a length of about four inches, a width of about three quarters of an inch, and a depth D of about one half of an inch; however, the dimensions maybe varied from these.

Turning now to FIGS. 9 through 17 trays for the making of the first form of ice sticks 100 will be discussed.

FIGS. 9 through 11 show a multi-compartmented lateral tray 200, which is preferably formed of plastic material, particularly a non-stick plastic (which, depending on the wetting action, as adduced by surface tension, may reduce or eliminate the peripheral ridge). Each lateral compartment 202 is formed downwardly in a tray table 208, having a wall 202a that is tub shaped complementary (having a length and a cross-section girth) to the aforementioned tub shape of the sidewall 116, and they are oriented in a mutually parallel arrangement in a longitudinal pattern of sets 204a, 204b, wherein the numbr of sets may be other than two, as shown. Preferably, the lateral tray 200 features water overflow channels 208 (thre corner type overflow channels being shown) between lateral compartments formed in the tray table 208 for providing self-leveling of water between compartments. A raised perimeter rim 210 abuts the tray table 208, and serves to prevent accidental spillage of water as the lateral tray 200 is transported, for example, from a sink to a freezer. The perimeter rim 210 may have a height of about ¼ inch above the tray table 208. Preferably, a perimeter base 212 is integral with the perimeter rim 210, wherein the perimeter base aids in grasping and handling of the lateral tray 200, wherein, preferably, the perimeter rim and the perimeter base are shaped to allow nesting of the lateral trays 200.

In operation, a user holds a lateral tray 200 level and fills it with water (or another liquid, such as a flavored drink), noting that all lateral compartments are about equally filled, then places the lateral tray into a freezer for freezing of the water into ice sticks 100. To remove the ice sticks, the lateral tray is grasped at each end and gently twisted. Other techniques of ice stick removal can be used, such as for example running warm water the tray to loosen the ice sticks from the wall 202a.

FIG. 11A is a depiction similar to FIG. 11, indicating that the lateral tray 2001 may have compartment walls 2021 which are of any tub-shape with rounded corners including the semi-circular shape shown for making the ice stick 100′.

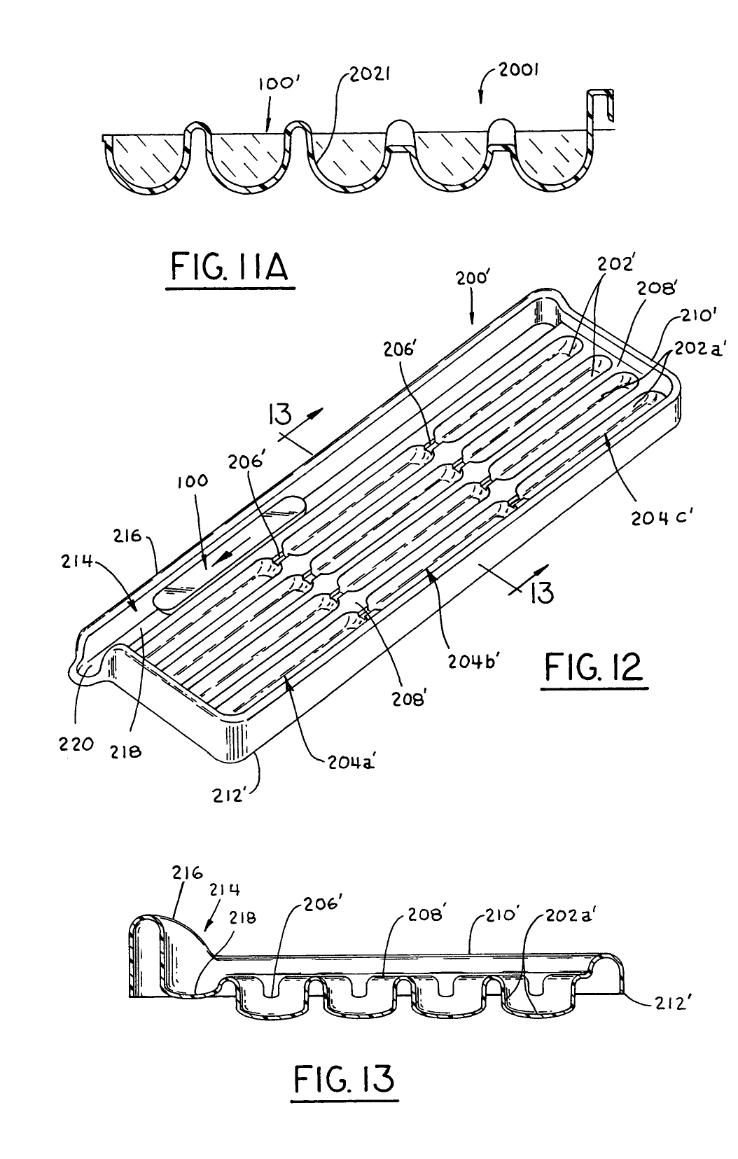

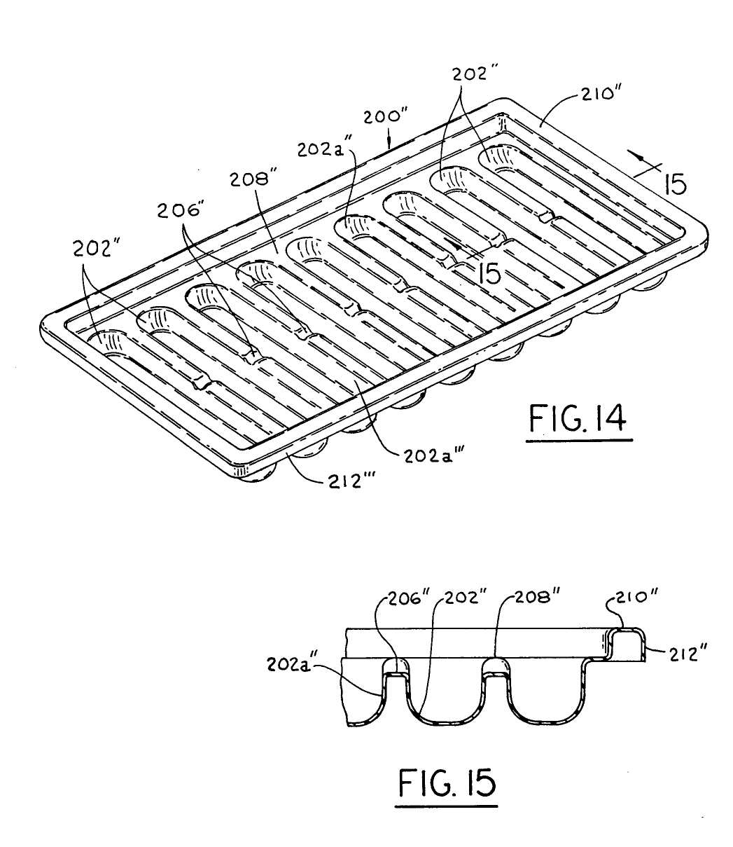

FIGS. 12 and 13 show a first variation of the lateral tray 200′ which includes an ice stick chute 214. Each lateral compartment 202′ has a wall 202a′ that is tub shaped complementary (having a length and cross-section girth) to the aforementioned tub shape of the sidewall 116, and they are oriented in a mutually parallel arrangement in a longitudinal pattern of sets 204a, 204b. 204c, wherein the number of sets may be other than three. Preferably, the lateral tray 200′ features water overflow channels 206′ for self-leveling of water between lateral compartments formed in tray table 208′. A raised perimeter rim 210′ abuts the tray tabl 108′ and serves, as mentiond previously, to prevent accidental spillage of watr as the lateral tray 200′ is transported from a sink to a freezer. A perimeter base 212′ is also preferably provided, wherein, preferably, the perimeter base and the perimeter rim are shaped to allow nesting of the lateral trays 200′

The ice stick chute 214 is integrated into one side to the perimeter rim 210′ at an orientation parallel with the lateral compartments 210′ at an orientation parallel with the lateral compartment 202′. The ice stick chute 214 includes a raised chute rim 216, a chute slot 218 for receiving ice sticks 100 and a portal 220 which allows exiting of the ice sticks from the chute without interference by the perimeter rim. For example, the raised rim 210′ may be raised about ¼ of an inch above the tray table 208′, and the chute rim 216 may be raised about one or more inches above the tray table 208′, and the chute rim 216 may be raised one or more inches above the tray table.

In operation, a user holds the lateral tray 200′ level and fills it with water (or another liquid, such as a flavored drink), noting that all lateral compartments are about equally filled. Then places the lateral tray into a freezer for freezing of the water into ice sticks 100. To remove the ice sticks, the lateral tray is grasped at each end and gently twisted. Other techniques of ice stick removal can be used, such as for example, running warm water over the lateral tray to loosen the ice sticks from the wall 202a′. By inclining the lateral tray 200′, the ice sticks slide toward the Ice stick chute 214 and fall into the chute slot 218. A second inclining of the lateral tray 200′ results In the ice sticks in the chute slot exiting at the portal 220.

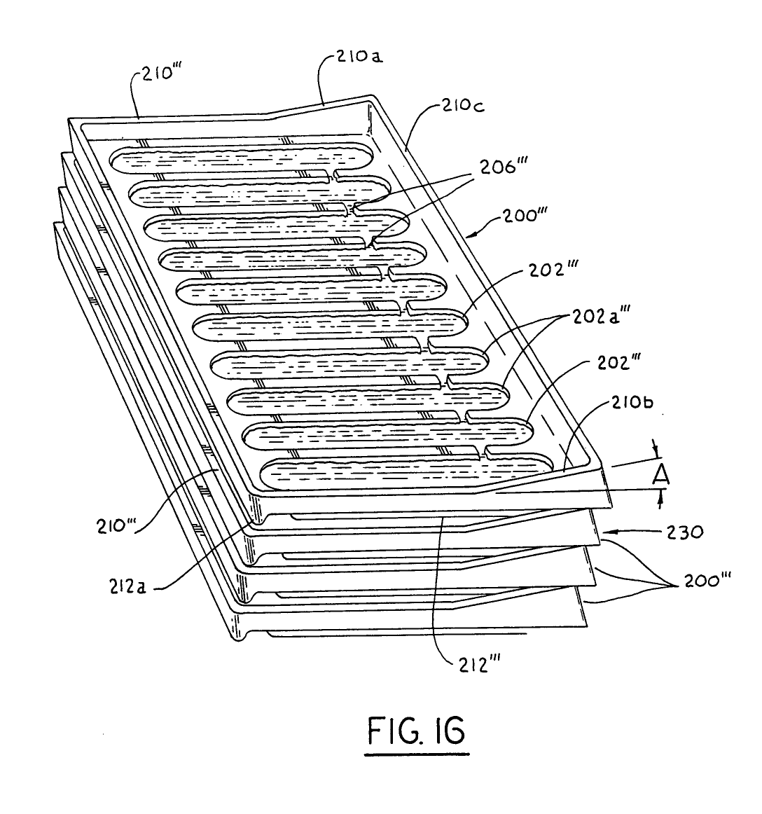

FIGS. 14 and 16 depict a yet another alternative tray 200′, wherein the lateral compartments 202″ are transversely arranged in the tray table 208″. Each lateral compartment 202″ has a wall 202a″ that is tub shaped complimentary to th aforementioned tub shape of the sidewall 116. Preferably, the lateral tray 200″ features water overflow channels 206″ for providing self-leveling of water between lateral compartments 202″ formed in the tray table 208″. A raised perimeter rim 210″ abuts the tray table 208″ and serves to prevent accidental spillage of water. Preferably, a perimeter base 212″ is integral with the perimeter rim 210″. and wherein, preferably, the perimeter base and perimeter rim are shaped to allow a nesting of the lateral tray 200″.

In operation, a user holds the lateral tray 200″ level and fills it with water (or with another liquid, such as flavored drink), noting that all lateral compartments are about equally tilled, then places the lateral tray into a freezer for freezing the water into ice sticks 100. To remove the ice sticks, the lateral tray is grasped at each end and gently twisted. Other techniques of ice stick removal can be used, such as for example, running warm water over the lateral tray to loosen the ice sticks from the wall 202a″.

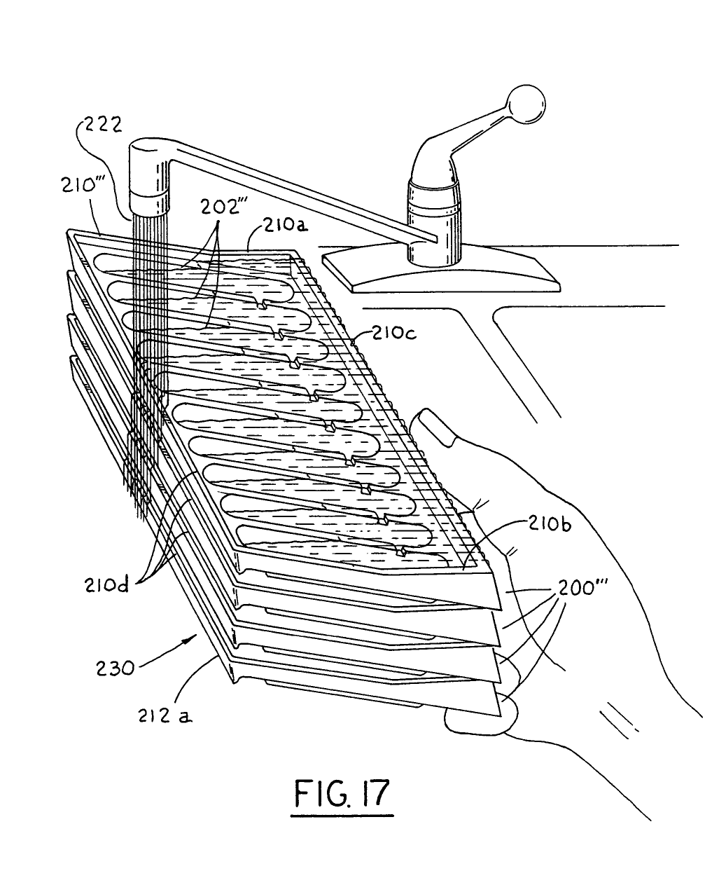

FIGS. 16 and 17 depict another variation of the lateral tray 200′″, wherein the raised perimeter rim 210′″ includes left and right inclined rim portions 210a, 210b and a raised rear rim portions 210e, 210b and a raised rear rim portion 210c connecting there between. A preferred angle A of incline of the left and the right inclined rim portions 210a, 210b is preferably about 10 degrees with respect to the remainder of the perimeter rim 210′″. A perimeter base 212′″ includes a raised front base portion 212a. Each lateral tray 200′″ includes a plurality of lateral compartments 202′″ formed downwardly in a tray table 208′″. Each lateral compartment having a wall 202a′″ that is tub shaped complementary to the aforementioned tub shape of the ice stick sidewall. The lateral compartments 202′″ are most preferably oriented transversely, as shown at FIGS. 16 and 17, although they could be oriented longitudinally. Overflow channels 206′″ connect adjacent lateral compartments 202′″ so that water may self-level there between.

The lateral trays 200′″ are mutually stackable by nesting into a stack 230. Nesting occurs because th left and right rim portions 210a and 210b taper toward each so that they are nestable into th perimeter base 212′″, a lateral tray placed there above, resting upon the underside of the tray table of the upper lateral tray. Further, nesting occurs because the front base portion 212a is inwardly tapered so as to rest inside the perimeter rim 210′″ of the lateral tray thereunder, resting upon the upper side of the lateral tray table thereunder.

In operation as shown at FIG. 17, a user grasps a stack 230 of lateral trays 200′″, so that they are inclined at an angle (that is, about 10°) making the left rim portions 210a, 210b approximately horizontal. Then a water stream 222 glancing onto each of the lateral trays 200′″, at a front rim portion 210d so as to simultaneously fill the lateral compartments 202′″, wherein water accumulates adjacent the rear rim portion 210c and eventually overflows it. When the lateral trays 200′″ are again returned to horizontal, as shown in FIG. 16, the water redistributes to equally fill all the lateral compartments 202′″, the lateral 200′″ may then be carried, still nestably stacked, to a freezer to form ice sticks 100. Removal of the ice sticks may be accomplished by twisting of the lateral trays 200′″ or by other means convenient to the user,

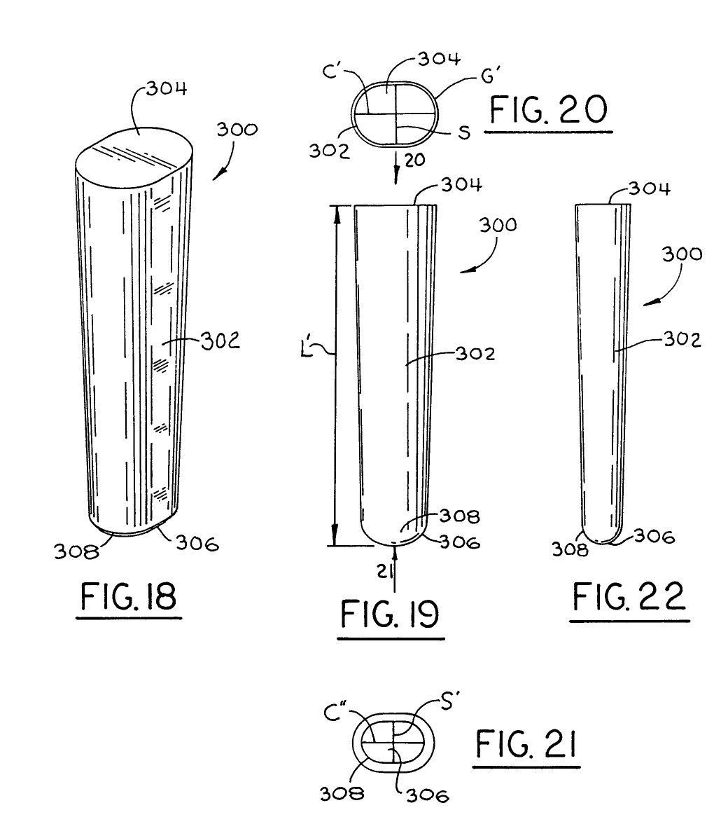

A second form of ice sticks 300 is depicted at FIGS. 18 through 22, The second form of ice stick 300 has a small girth G′ body, defined by a generally elliptical cross-sectioned sidewall 302. The sidewall 302 gently tapers from a generally flat upper surface 304 (formed by water level at the time of freezing) toward an opposite, small cross-sectioned, bottom face 306. The bottom face 308 is preferably convex and gently rounded at the interface 308 when the sidewall meets the bottom face, but this is not required.

Again, as in the first form of the ice stick 100, the largest cross-section diameter C′ (which is the major axis of the elliptical cross-section) (oval shape) is in the order close than one inch, preferably about three-quarters of an inch or less. The elliptical shape provides large bulk, longitudinal strength and ease of passage through a narrow opening, and the short minor axis allows for the passage through a tab opening 106. The taper of the sidewall 302 provides easy extraction from the tray lateral compartment in which it was formed, and the convex narrower bottom face 306 provides an easy first-to-enter end for insertion into a narrow opening of a container. The length may any convenient length, as for example, between one inch to about five inches. There may, or not be a peripheral ridge formed at the interface between the upper face 304 and the sidewall 302.

Preferred dimensions of the second form of the ice stick 300 are in the order of: a length of about one inch to about three inches long, wherein the upper face 304 of the ellipse has a major axis C′ of about three-quarters of an inch and a minor axis S of about ½ of an inch, and wherein at the lower face 306, the ellipse has a major axis C″ of about fiveeights of an inch and a minor axis S′ of about three-eights of an inch to about seven sixteens of an inch, however the dimensions may be varied from the above.

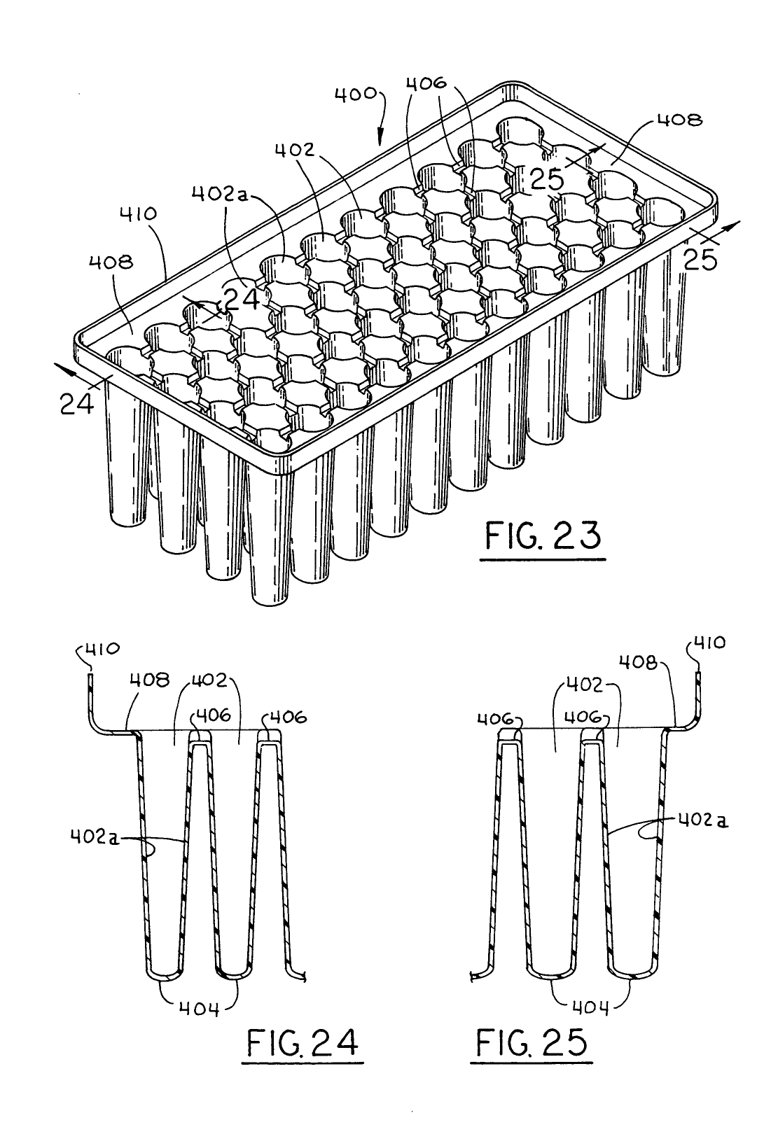

To provide the second form of ice sticks, a vertical tray 400 is provided, as shown at FIGS. 23 through 26, preferably formed of plastic, particularly non-stick plastic. The vertical tray 400 has a plurality of vertical compartments 402 formed downwardly from the tray table 408, as for example, having forty eight vertical compartments, Each vertical compartment 402 is closed at (at a preferably interiorly convexly contoured) bottom 404 and open at the top. Each vertical compartment 402 has a wall 402a having a tapering elliptically shaped cross-section which is complimentary (having a length an cross-section girth) to the tapering elliptical shape of the sidewall 302 of the second form of ice stick 300. Preferably, water overflow channels 406 between adjacent vertical compartments are formed in the tray table 408 for providing self-leveling of water there between. A raised perimeter rim 410 abuts the tray table 408 and serves to prevent accidental spillag of water.

It will be appreciated that the taper of the second form of ice sticks 300. and the complimentary taper of the vertical compartments 402 allow for easy extraction of the ice sticks, in that any degree of movement of an ice stick relative to the vertical compartment results in separation everywhere, which effect may not occur if the vertical compartment were cylindrical without a taper. Also, the elliptical cross-section form of ice stick 300 allows for maximum cross-section which yet can pass through a stay-on tab can opening.

In operation, a user holds the vertical tray 400 level and fills it with water (or another liquid, such as a flavored drink) noting that all vertical compartments are about equally filled, then places the vertical tray into a freezer for freezing the water into ice sticks 300. To remove the ice sticks, the vertical tray is placed into running or pooled warm water to loosen the sidewall 302 of the ice sticks 300 from the wall 402a. Since the vertical tray 400 can be molded of resilient plastic, the convex bottom provides a spot where pressure may be applied to the vertical tray to deform the convex and thereby push the ice stick 300 therein upwardly therefrom. Ice stick extraction in this manner can be conveniently performed by pressing the convex bottom 404 against a counter top, or selectively against an edge of a counter top, wherein the resilient denting of the convex bottom forces the ice stick upward.

While the ice sticks 100, 300 were described herein above with respect to frozen water, the frozen water may be pure or may be composed of any type of frozen drinkable water, as for example, a flavored water drink, including, for example, a flavored water drink, orange juice, grape juice, etc.

To those skilled in the art to which this invention pertains, the above described embodiments may be subject to change or modification. Such change or modification can be carried out without departing from the scope of the invention, which is intended to be limited only by the scope of the appended claims.

1. A small girth dice article, comprising:
a body of ice having a generally rectangular shape characterized by a generally flat upper face and a sidewall, said sidewall having rounded corners. wherein a substantially right angle interface is formed between said upper face and said sidewall, and wherein said body of ice has a length of between five inches to one inch and a girth, wherein the widest girth cross-sectional diameter is less than one inch.

2. The small girthed ice article of claim 1, wherein said girth has a width of three quarters of an inch and a depth of one half of an inch.

3. The small girthed ice article of claim 1, wherein said length is four inches.

4. A small girthed ice article comprising:
a body of ice having a generally flat upper face, an opposite bottom face a generally elliptical cross-section sidewall there between, said sidewall being gently tapered from said upper face toward said bottom face, and wherein said body of ice has a length of between five inches to one inch and a girth, wherein a widest girth cross-sectional diameter is less than one inch.

5. The small girthed article of claim 4, wherein said bottom face is convexly contoured.

6. The small girthed article of claim 4, wherein said girth at said upper face has an elliptical major axis of three-quaters of an inch, and whrein at the lower face said girth has an elliptical major axis of five-eights of an inch and an elliptical minor axis of less than one halt of an inch.

7. The small girthed ice article of claim 4, wherein said length is four inches.

8. A small girthed ice article comprising:
a body of ice having a generally rectangular shape characterized by a length dimension, a width dimension perpendicular to said length dimension and a depth dimension perpendicular to said length an width dimension, said body having a generally flat upper face located in a plane defined by an intersection of said length and width dimensions, and a generally tub-shaped sidewall having a pair of mutually opposed corners, wherein a substantially right angle interface is formed between said upper face an said sidewall and wherein said upper face is rounded with respect to said length and width dimensions at each corner of said pair of corners, and wherein said sidewall is rounded downwardly from said face at each corner three dimensionally with respect to all of said length, width and depth dimensions.

9. The small girthed ice article of claim 8, wherein said body of ice has a length of between five inches to about one inch, and wherein said body of ice has girth, wherein a widest cross-sectional diameter is less than about one inch.

10. The small girthed ice article of claim 9, wherein said girth has a width of about three-quarters of an inch and a depth of a about one-half of an inch.

11. The small girthed ice article of claim 10, wherein said length is about four inches.

12. A tray for making a small girthed ice article, comprising:
a tray table having a plurality of lateral compartments downwardly formed therein, each lateral compartment having a sidewall characterized by rounded corners, wherein each lateral compartment has a length of between five inches and one inch, and wherein each of said compartments has a girth cross-section, wherein a widest girth cross-Section is less than one inch.

13. The tray of claim 12, wherein said girth cross-section has a width of three-quarters of an inch and a depth of one half of an inch.

14. The tray of claim 13 further comprising a plurality of overflow channels formed in said tray table, wherein said overflow channels provide a path for self-leveling water between adjacent lateral compartments.

15. The tray of claim 14, wherein said tray table has a perimeter, further comprising a rim integrally formed with said tray table at said perimeter, said rim rising upwardly in relation to said tray table.

16. The tray of claim 16 comprising a chute means integrally formed of said tray table at an orientation parallel to said length of said lateral compartment for providing a channel for receiving small girthed ice articles formed in said lateral compartments and for exiting the received small girthed ice articles from the tray at a portal thereof.

17. Th tray of claim 16, wherein said rim has a first raised height, and wherein a raised rear portion has a second raised height which extends higher than said first raised height, said tray further comprising a perimeter base means integrally connected with said rim and projecting downwardly therefrom; wherein a plurality of trays are nestably stackable.

18. A tray for making a small girthed ice article comprising:
a tray table having a plurality of vertical compartments downwardly formed therein, each of said vertical compartments having a closed bottom, an open top, and elliptically shaped wall characterized by rounded corners, wherein the wall of each said compartments has a length of between five inches and one inch, and wherein the wall of each of said compartments has a tapered girth, wherein a widest girth cross-sectional diameter is less than one inch.

19. The tray of claim 18, wherein said girth of said open top has an elliptical major axis of three-quarters of an inch and elliptical minor axis of one-half of an inch, and wherein at said closed bottom said girth cross-sectional diameter has an elliptical major axis of five-eigths of an inch and an elliptical minor axis of less than one-half of an inch.

20. The tray of claim 19 further comprising a plurality of overflow channels formed in said tray table, wherein said overflow channels provide an overflow path for water between adjacent vertical compartments, and wherein said tray table has a perimeter, said rim rising upwardly in relation to said tray table.

21. The tray of claim 20, wherein the closed bottom of each of said vertical compartments is convexly contoured.

22. A method of filling a number of ice making trays with water simultaneously, wherein each tray comprises a tray table having a plurality of lateral compartments downwardly formed therein, each lateral compartment having a tub-shaped wall having a length of between five inches and one inch, wherein each of said literal compartments has a girth cross-section, wherein one row of overflow channels formed in said tray are property located near the rear to act as a tilt indicator and overflow for water between adjacent lateral compartments and wherein a widest girth cross-section is less than one inch, wherein overflow channels formed in said tray table provide an overflow path for water between adjacent lateral compartments wherein said tray table has a perimeter, a front rim is integrally formed with said tray table, and a rear rim is integrally formed with said tray table, said method including the steps of:
nestably stacking a plurality of trays including at least one repeating series of an upper tray above a lower tray;
grasping said stack of trays;
orienting said stack of trays so that the tray table of each tray is inclined at a selected acute angle with respect to a horizontal so that the tray is inclined downwardly from the front rim toward the rear rim;
placing the front of each tray glancingly into a water stream so that water of the water stream glances onto each of said trays of said stack of trays to simultaneously fill the trays, wherein water accumulates adjacent the rear rim of each of said trays; and
orienting said stack of trays so that said tray table of each of said trays is substantially horizontal and whereupon the water in each of said trays redistributes to equally fill all of said compartments thereof.
